(19) United States
(12) Patent Application Publication
(10) Pub. No.: US 2006/0071925 A1
(43) Pub. Date: Apr. 6, 2006

(54) Wireless display update system without a local power source

(76) Inventors: Richard C. Wykoff, Hillsboro, OR (US); Lewis E. Adams III, Carmel, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/959,279

(22) Filed: Oct. 5, 2004

(51) Int. Cl. G09G 5/00

(52) U.S. Cl. 345/211

(57) ABSTRACT

According to some embodiments, a received radio frequency (RF) signal is used to power a display update system and a display device. The received radio frequency signal also includes information to update the display device. The display update system may include a voltage processing unit to derive power from the signal, a processor to demodulate, optionally decrypt, and optionally authenticate the signal.

### BACKGROUND

### DESCRIPTION OF THE RELATED ART

Electronic displays are becoming popular in retail, manufacturing and other environments where manually updating displays can be time consuming and prone to error. Electronic displays can provide useful information about items on a shelf, in a container, and the like while providing the ability to be easily updated. For example, supermarkets can provide displays with current pricing for products. A tablet type display can indicate a log of items placed in or to be placed in a container. Movie show times can be displayed and updated at a movie theater. However, electronic displays can be expensive due to power source requirements. Batteries and power connections are prohibitively expensive and cumbersome when a large number of displays are attached to portable items or shelves.

### BRIEF DESCRIPTION OF THE DRAWINGS

The present invention may be better understood, and its numerous features and advantages made apparent to those skilled in the art by referencing the accompanying drawings.

FIG. 1 illustrates a bi-stable display update system 100 according to an embodiment of the present invention.

FIG. 2 illustrates a display update unit and antenna system 200 according to an embodiment of the present invention.

FIG. 3 illustrates a flow diagram for a display update unit according to an embodiment of the present invention.

FIG. 4 illustrates a flow diagram for a reader/writer according to an embodiment of the present invention.

The use of the same reference symbols in different drawings indicates similar or identical items.

### DESCRIPTION OF THE EMBODIMENT(S)

In the following description, numerous specific details are set forth. However, it is understood that embodiments of the invention may be practiced without these specific details. In other instances, well-known methods, structures and techniques have not been shown in detail in order not to obscure an understanding of this description.

References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Unless specifically stated otherwise, as apparent from the following discussions, it is appreciated that throughout the specification discussions utilizing terms such as “processing,” “computing,” “calculating,” or the like, refer to the action and/or processes of a computer or computing system, or similar electronic computing device, state machine and the like that manipulate and/or transform data represented as physical, such as electronic, quantities into other data similarly represented as physical quantities.

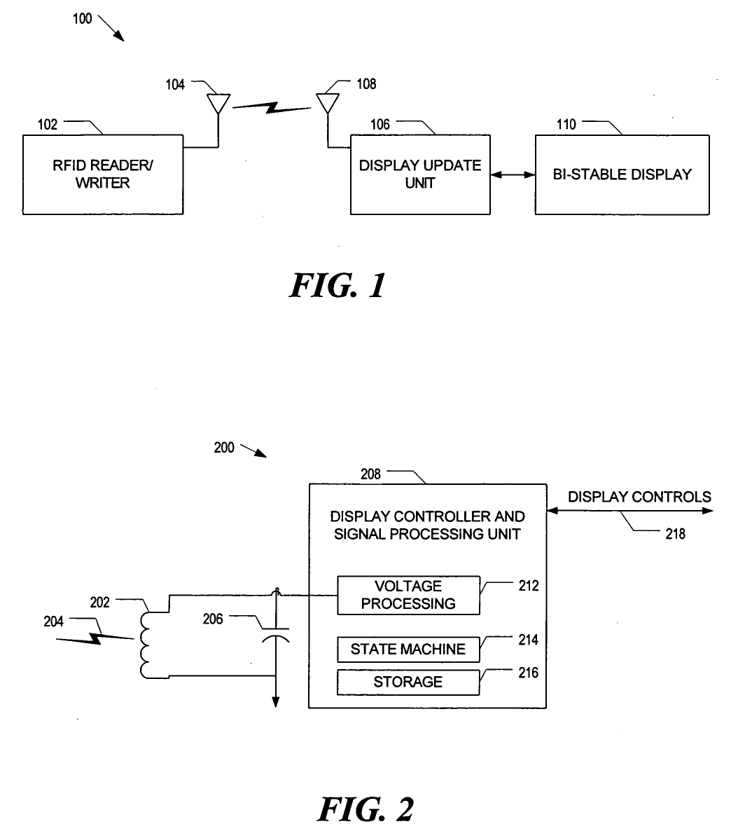

FIG. 1 illustrates a bi-stable display update system 100 according to an embodiment of the present invention. System 100 includes a radio frequency identification (RFID) reader/writer 102 having antenna 104, a display update unit 106 having antenna 108, and a bi-stable display device 110.

RFID technology is well known. A RFID reader/writer sends out electromagnetic waves to one or more RFID tags that induce a current in the tag's antenna. The tag antenna is tuned to receive these waves. A passive RFID tag draws power from the field created by the reader/writer and uses the power to power a microchip's circuits. The chip then modulates the waves that the tag sends back to the reader/writer to be converted into digital data. Additional blocks of data can be used to store additional information about the items the tag is attached to. The tag could be powered and information exchanged through either inductive coupling or backscatter. RFID systems use many different frequencies, but generally the most common are low (around 125 KHz), high (13.56 MHz) and ultra-high (850-900 MHz. Microwave (2.45 Ghz) is also used in some applications.

RFID reader/writer 102 is capable of sending and receiving radio frequency (RF) signals with display update unit 106. RFID reader/writer 102 is different from standard RFID reader/writers in at least that RFID reader/writer 102 transmits display update information to display update unit 106. Display update unit 106 receives RF signals from RFID reader/writer 102, processes the signals utilizing power gained from the RF signals, and updates bi-stable display device 110 according to information received in the RF signals. Display update unit 106 and bi-stable display 110 do not contain a local power source and derive all power from the received RF signals.

Display device 110 retains the desired message after the power is removed due to the bi-stable nature of the display. As the term bi-stable implies, picture elements of display device 110 are stable in two or more states. Display device 110 needs power only when the information displayed changes.

Bi-stable display device 110 may utilize, for example, magnetic or liquid crystal display technologies. Magnetic display technology uses electrostatic charges on tiny spheres that are suspended in a plane. One side of each sphere may be, for example, black, the other may be, for example, white. Each side of a sphere is attracted to an opposite electrical charge. When a charge is placed across the front and back layers of the panel, the spheres respond. Thus, for example, a first charge causes the white sides to be displayed, and a second charge causes the black sides to be displayed. When power is removed, the spheres retain their current orientation. Liquid crystal display technology uses standard liquid crystal material. The material normally loses its image when the electrical charge is removed. For bi-stable displays the alignment bond of the bottom layer of the liquid crystal substrate is broken so that it can come to rest in its alternative state. Two types of bi-stable display technologies are described. Alternate embodiments of display device 110 may utilize other technologies. The invention is not limited in this context.

In an alternate embodiment of the present invention, processing of the RF signal by display update unit 106 may include decryption and authentication to protect against malicious update of display device 110. Any type of authentication protocol may be used, for example, one-way and two-way protocols. The invention is not limited in this context.

In an alternate embodiment of the present invention, display update unit 106 may send a status or confirmation message back to RFID reader/writer 102.

In an alternate embodiment of the present invention, display device 110 may be capable of communicating the current displayed information to display update unit 106.

In an alternate embodiment of the present invention, system 100 may comprise, for example, multiple display update units 106 and bi-stable display devices 110 in any number of different topologies. Further, a single display update unit 106 may be configured to update multiple bi-stable display devices 110. The embodiments are not limited in this context.

FIG. 2 illustrates a display update unit and antenna system 200 according to an embodiment of the present invention. An inductor 202 receives an RF signal 204 from, for example, RFID reader/writer 102, and charges one or more capacitors 206 to generate power to operate a display controller and signal processing unit 208. Display controller and signal processing unit 208 includes a voltage processing unit 212, a state machine or processor 214, and a storage 216. Voltage processing unit 212 may include, for example, protection circuitry such as a diode and a voltage regulator. Storage 216 retains its current state without power, and may be, for example, a non-volatile memory such as a flash memory. However, the invention is not limited in this context.

Display controller and signal processing unit 208 receives and processes the RF signal 204 with state machine 214. This processing may include, for example, demodulation, decryption, and authentication of the signal. Additionally, display update information in RF signal 204 is used to generate display controls 218. In one embodiment, display information received in RF signal 204 is compared to current display information stored in storage 216. Storage 216 may also include a key for decryption, a device identification for signal authentication and other such information.

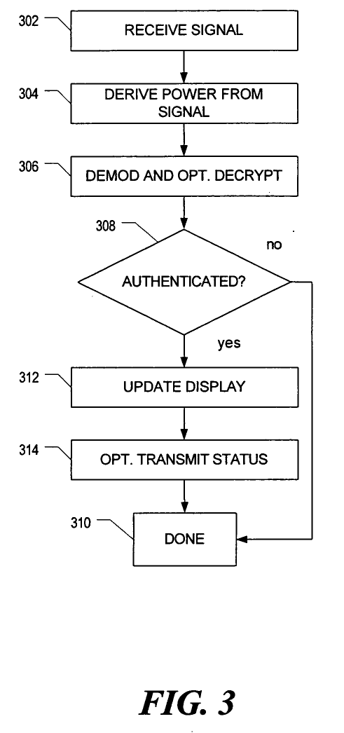

FIG. 3 illustrates a flow diagram for a display update unit according to an embodiment of the present invention. An RF signal is received, block 302. Power is derived from the signal for signal processing, block 304. The signal is demodulated into a digital signal and optionally decrypted, block 306. The signal is optionally authenticated, block 308. If authentication is not achieved, processing discontinues, block 310. If authentication is achieved, the display is updated according to the received signal, block 312. Optionally, a status signal can be sent acknowledging successful update, block 314.

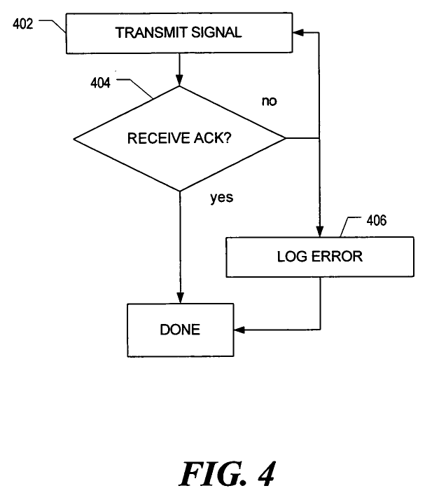

FIG. 4 illustrates a flow diagram for a reader/writer according to an embodiment of the present invention. An RFID reader/writer transmits an RF signal to a display update system, block 402. An antenna of the RFID reader/writer is tuned to an antenna attached to the display update system. The RF signal includes enough power such that the display update system can process the signal and update a display device. The RF signal may include device identification, authentication information and may be encrypted. The transmitted RF signal also includes information to update the display device. The RFID reader/writer may optionally receive an acknowledgement signal from the display update system, block 404. If not received, the RFID reader/writer may retransmit the RF signal, block 402 and/or log an error, block 406.

Although discussed above with reference to RFID like systems, other types of wireless communication systems are intended to be within the scope of the present invention including, although not limited to, Wireless Local Area Network (WLAN), Wireless Wide Area Network (WWAN), Worldwide Interoperability for Microwave Access (WiMax), Wireless Personal Area Network (WPAN), Wireless Metropolitan Area Network (WMAN), Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, Universal Mobile Telecommunications System (UMTS), and the like, although the scope of the invention is not limited in this respect. In at least one implementation, for example, a wireless link is implemented in accordance with the Bluetooth short range wireless protocol (Specification of the Bluetooth System, Version 1.2, Bluetooth SIG, Inc., November 2003, and related specifications and protocols). Other possible wireless networking standards include, for example: IEEE 802.11 (ANSI/IEEE Std 802.11-1999 Edition and related standards), IEEE 802.16 (ANSI/IEEE Std 802.16-2002, IEEE Std 802.16a, March, 2003 and related standards), HIPERLAN 1, 2 and related standards developed by the European Telecommunications Standards Institute (ETSI) Broadband Radio Access Networks (BRAN), HomeRF (HomeRF Specification, Revision 2.01, The HomeRF Technical Committee, July, 2002 and related specifications), and/or others.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

What is claimed is:

1. An apparatus comprising:
an antenna; and
a display update system coupled to the antenna, the display update system to update a display device according to a signal received on the antenna;
wherein power to update the display device is derived from the signal received on the antenna.

2. The apparatus as recited in claim 1, the display update system further to authenticate the signal.

3. The apparatus as recited in claim 1, the display update system further to decrypt the signal.

4. The apparatus as recited in claim 1, wherein the display device is a magnetic technology bi-stable display device.

5. The apparatus as recited in claim 1, wherein the display device is a liquid crystal display bi-stable display device.

6. The apparatus as recited in claim 1, the display update system comprising a voltage processor to regulate power from the signal.

7. The apparatus as recited in claim 1, the display update system comprising storage to store a current state of the display device.

8. The apparatus as recited in claim 7, the display update system further comprising a processor to compare the current state of the display device with a desired state received in the signal.

9. The apparatus as recited in claim 8, the processor further to generate control signals for the display device.

10. The apparatus as recited in claim 1, the display update system further to send an acknowledgment signal via the antenna.

11. The apparatus as recited in claim 1, the display device to provide the display update system with a current state of the display device.

12. The apparatus as recited in claim 7, the display update system further comprising a processor to compare the current state of the display device with a desired state received in the signal.

13. A method comprising;
receiving a wireless update signal;
deriving power from the wireless update signal;
updating a display device according to information in the wireless update signal wherein the updating is powered by the power derived from the wireless update signal.

14. The method as recited in claim 13, further comprising sending a wireless status signal, wherein the sending is powered by the power derived from the wireless update signal.

15. The method as recited in claim 13, further comprising decrypting the wireless update signal.

16. The method as recited in claim 13, further comprising authenticating the wireless update signal.

17. The method as recited in claim 13, further comprising comparing a current state of the display device with a desired state of the display device, the desired state received in the wireless update signal.

18. The method as recited in claim 13, wherein the display device is a magnetic technology bi-stable display device.

19. The method as recited in claim 13, wherein the display device is a liquid crystal display bi-stable display device.

20. A system comprising:
a display update unit;
a display device coupled to the display update unit;
the display update unit to receive and derive power from a wireless signal, and to update the display device; and
wherein power to update the display device is derived from the wireless signal.

21. The system as recited in claim 20, the display update system further to authenticate the signal.

22. The system as recited in claim 20, the display update system further to decrypt the signal.

23. The system as recited in claim 20, wherein the display device is a magnetic technology bi-stable display device.

24. The system as recited in claim 20, wherein the display device is a liquid crystal display bi-stable display device.

25. The system as recited in claim 20, the display update system comprising a voltage processor to regulate power from the signal.

26. The system as recited in claim 20, the display update system comprising storage to store a current state of the display device.

27. The system as recited in claim 26, the display update system further comprising a processor to compare the current state of the display device with a desired state received in the signal.

28. The system as recited in claim 27, the processor further to generate control signals for the display device.

29. A method comprising:
transmitting a wireless signal to a display update system, the wireless signal including a desired display state to be reflected on a display device, the display update system deriving power from the wireless signal to update the display device.

30. The method as recited in claim 29, wherein the wireless signal is transmitted with an antenna tuned to an antenna on the display update system.

31. The method as recited in claim 29, further comprising encrypting the wireless signal.

32. The method as recited in claim 29, wherein the wireless signal includes authentication information.

33. The method as recited in claim 29, further comprising receiving a status signal from the display update system, the status signal indicating successful update of the display device.
